(19) United States
(12) Patent Application Publication
(10) Pub. No.: US 2026/0220130 A1
(43) Pub. Date: Jul. 30, 2026

(54) AMBIGUITY-GUIDED QUERY REWRITE FOR AN ARTIFICIAL INTELLIGENCE CHAT AGENT

(71) Applicant: Adobe Inc., San Jose, CA (US)

(72) Inventors: Md Mehrab Tanjim, Santa Clara, CA (US); Yunyao Li, San Jose, CA (US); Xiang Chen, San Jose, CA (US); Victor Soares bursztyn, Redwood City, CA (US); Vaishnavi Muppala, San Jose, CA (US); Uttaran Bhattacharya, Sunnyvale, CA (US); Tung Thanh Mai, San Jose, CA (US); Saayan Mitra, San Jose, CA (US); Kenneth G. Russell, Mountain View, CA (US); Eunyee Koh, San Jose, CA (US); Akash Vivek Maharaj, Palo Alto, CA (US)

(73) Assignee: Adobe Inc., San Jose, CA (US)

(21) Appl. No.: 19/041,252

(22) Filed: Jan. 30, 2025

(51) Int. Cl. G06F 16/2452; G06F 16/242

(52) U.S. Cl. CPC G06F 16/24522; G06F 16/243

(57) ABSTRACT

In accordance with the described techniques, a query is received from a user for processing by an artificial intelligence (AI) chat agent. An ambiguity classifier model is leveraged to determine whether the query is ambiguous. Responsive to determining that the query is ambiguous, a query rewrite model is leveraged to update the query to resolve one or more ambiguities of the query, and the updated query is provided to the AI chat agent for processing. Responsive to determining that the query is unambiguous, the query is provided to the AI chat agent for processing.

### BACKGROUND

Large language models (LLMs), such as those based on neural networks and deep learning, are designed to understand, generate, and/or manipulate human language. LLMs are able to process vast amounts of data and learn patterns. Accordingly, LLMs are used for a variety of applications such as language translation, dialogue recognition, and natural language understanding. For instance, LLMs are often used as a component of AI chat agents, such as to generate natural language responses to user queries. However, LLMs encounter challenges when dealing with ambiguous queries. Ambiguity in user queries, such as vague phrasing, multiple meanings, lack of context, and so on, results in incorrect or irrelevant responses generated by LLMs.

### SUMMARY

An ambiguous query rewrite system is described that is configured to receive a query for processing by an artificial intelligence (AI) chat agent. The AI chat agent is a software program that leverages AI (e.g., a large language model (LLM)) to generate conversational responses to user-submitted queries. The ambiguous query rewrite system feeds the query to an ambiguity classifier model, which is trained to classify queries as ambiguous or unambiguous.

In response to classifying the query as ambiguous, the ambiguous query rewrite system updates the query to resolve query ambiguities. This is done, in part, by building a prompt that includes the query, a chat history between the user and the AI chat agent, and one or more instructions that request a query rewrite model (e.g., an LLM) to update the query to resolve ambiguities based on the chat history. The prompt is provided as input to the query rewrite model, which generates an updated query by rewriting the query based on the instructions and data within the prompt. The updated query is then provided as input to the AI chat agent, which generates a response by processing the updated query. The response is then output for display in a user interface.

If, however, the ambiguity classifier model classifies the query as unambiguous, the ambiguous query rewrite system bypasses the query rewrite model. That is, the unedited query is provided directly to the AI chat agent for processing, without first editing or modifying the query. The AI chat agent generates a response by processing the unedited query, and the response is output for display in the user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

Entities represented in the figures are indicative of one or more entities and thus reference is made interchangeably to single or plural forms of the entities in the discussion.

FIG. 1 is an illustration of an environment in an example implementation that is operable to employ techniques described herein for ambiguity-guided query rewrite for an artificial intelligence (AI) chat agent.

FIG. 2 depicts a system in an example implementation showing operation of an ambiguous query rewrite system to determine whether to rewrite a query based on query ambiguity.

FIG. 3 depicts a system in an example implementation showing operation of an error forecasting module to forecast an error rate at which an ambiguity classifier model misclassifies queries.

FIG. 4 depicts a system in an example implementation showing operation of an ambiguous query rewrite system to select an ambiguity classifier.

FIG. 5 depicts an example of a user interface displayed in accordance with the described techniques.

FIG. 6 is a flow diagram depicting an algorithm as a procedure in an example implementation that is performable by a processing device to determine whether to bypass a query rewrite for an AI chat agent.

FIG. 7 is a flow diagram depicting an algorithm as a procedure in an example implementation that is performable by a processing device to forecast an error rate for an ambiguity classifier model.

FIG. 8 is a flow diagram depicting an algorithm as a procedure in an example implementation that is performable by a processing device to select an ambiguity classifier model for ambiguity-guided query rewrite for an AI chat agent.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

### Overview

An artificial intelligence (AI) chat agent is a software program designed to simulate human-like conversations with a user using AI, e.g., by leveraging machine learning models, large language models (LLMs), natural language processing (NLP) techniques, and/or natural language understanding (NLU) techniques. By way of example, a user submits a query to the AI chat agent including questions, commands, and/or requests for information, and the AI chat agent uses AI to generate a conversational response (e.g., an answer) that addresses the questions, commands, and/or requests of the query. Oftentimes, however, user-submitted queries contain ambiguities, such as vague context or insufficient information, query terms that have multiple interpretations, use of ambiguous pronouns, and typographical errors. When responding to ambiguous queries, the AI chat agent often generates inaccurate or irrelevant responses. To address the response errors caused by ambiguous queries, AI chat agents often employ a query rewrite model (e.g., an LLM) to rewrite and/or update user-submitted queries to resolve ambiguities.

Conventional query rewrite techniques, however, rewrite queries unconditionally. That is, conventional techniques rewrite all queries submitted by a user regardless of whether the queries are ambiguous or not. Rewriting unambiguous queries unnecessarily increases the risk of the query rewrite model (e.g., the LLM) introducing hallucinations to the queries, which causes inaccurate responses. This problem is further exacerbated by the notion that the user frequently asks questions that depend on information from these inaccurate responses, which leads to even more inaccurate responses.

In addition, unconditionally rewriting queries involves unnecessarily processing unambiguous queries using query rewrite model(s). Since these models are typically implemented using publicly available LLMs, each query rewrite instance involves communicating the query over a network to an API endpoint, rewriting the query using the LLM, and receiving a response that includes the rewritten query. This operation is costly in terms of latency, network bandwidth consumption, and processing resource consumption, e.g., to process the query using the LLM.

To address the limitations of conventional techniques, techniques for ambiguity-guided query rewrite for an AI chat agent are described. In various implementations, the AI chat agent is an enterprise AI chat agent deployed in connection with products, software applications, and services of an enterprise, e.g., a business or organization. That is, the AI chat agent is designed to generate accurate conversational responses to enterprise-specific commands, requests, questions, and the like. One example of an enterprise is a software company that makes software applications available for use to its subscribers.

In accordance with the described techniques, an ambiguous query rewrite system receives a query submitted by a user for processing by the AI chat agent. The query is fed as input to an ambiguity classifier model, which is a machine learning model trained to classify queries as ambiguous or unambiguous. In one example, the ambiguity classifier model is trained from scratch (e.g., starting with randomly initialized parameters) on a dataset including training queries entered via the enterprise AI chat agent, e.g., including enterprise-specific terminology. By training the ambiguity classifier model in this manner, the ambiguity classifier model is smaller (e.g., in terms of memory consumption) and faster (e.g., in terms of inferencing latency) than publicly available LLMs. Accordingly, the enterprise is able to store and run the ambiguity classifier model on hardware resources (e.g., memory and processors) owned and operated by the enterprise, e.g., which is not the case when using a publicly available LLM for ambiguity classification.

In response to the ambiguity classifier model classifying the query as ambiguous, the ambiguous query rewrite system is configured to build a prompt requesting a query rewrite model to rewrite the query for ambiguity reduction. In one or more implementations, the prompt includes a chat history (e.g., the last five queries submitted to the AI chat agent and corresponding responses to the queries), and an instruction to resolve ambiguities in the query based on the chat history. Additionally or alternatively, the prompt includes one or more specific instructions to clarify ambiguous pronouns in the query, and/or correct typographical errors in the query. In various implementations, the query is received in connection with a particular domain (e.g., a digital product offered by the enterprise) associated with domain-specific terminology (e.g., product-specific terms associated with the digital product), and the prompt includes one or more instructions to preserve the domain-specific terminology within the query.

Once the prompt is built, the prompt is fed as input to a query rewrite model, which is a machine learning model trained and/or prompted to rewrite queries for ambiguity reduction. In some examples, the query rewrite model is a publicly available LLM, accessible via application programming interface(s) (API(s)). Thus, the ambiguous query rewrite system communicates the prompt and the query over a network to an API endpoint associated with the LLM (e.g., via an API call). Further, the ambiguous query rewrite system receives a response that includes an updated query as rewritten by the LLM in accordance with the input data and instructions of the prompt, e.g., to resolve query ambiguities. The ambiguous query rewrite system provides the updated query as input to the AI chat agent, and the AI chat agent generates a response to the updated query by processing the updated query. The response is then output for display in a user interface.

In response to the ambiguity classifier model classifying the query as unambiguous, however, the ambiguous query rewrite system provides the unedited query directly to the AI chat agent for processing, e.g., without sending the query to the query rewrite model for rewriting. Here, the AI chat agent generates a response to the unedited query, and the response is output for display in the user interface. Thus, the ambiguous query rewrite system is configured to solely send the query to the query rewrite model for ambiguity reduction if the query is classified as ambiguous, but the ambiguous query rewrite system bypasses the query rewrite model when the query is classified as unambiguous.

In various implementations, the ambiguity classifier model is selected for use in the ambiguous query rewrite system based on a forecasted error rate of the ambiguity classifier model. To forecast the error rate, a dataset is received including a plurality of queries. Each query in the dataset is associated with a rewritten query as generated by the query rewrite model for ambiguity reduction, and a corresponding response as generated by the AI chat agent by processing the rewritten query. Moreover, each query in the dataset is marked with an ambiguity indication specifying whether the query is ambiguous or unambiguous, as well as a response accuracy indication specifying whether the corresponding response (e.g., to the rewritten query) is correct.

To forecast the error rate, a recall value and a precision value associated with the ambiguity classifier model are received. Further, the ambiguous query rewrite system identifies, from the dataset, first queries that are marked as being ambiguous (e.g., via the ambiguity indication), and having the corresponding responses that are correct, e.g., via the response accuracy indication. In addition, the ambiguous query rewrite system determines a first misclassification count of the first queries that are misclassified by the ambiguity classifier model based on the recall value. Moreover, the ambiguous query rewrite system identifies, from the dataset, second queries that are marked as being unambiguous (e.g., via the ambiguity indication), and having the corresponding responses that are incorrect, e.g., via the response accuracy indication. The ambiguous query rewrite system determines a second misclassification count of the second queries that are misclassified by the ambiguity classifier model based on the recall value and the precision value. The forecasted error rate is a sum of the first and second classification counts divided by the total queries in the dataset.

Notably, the ambiguous query rewrite system omits third queries and fourth queries from the computation of the error rate. The third queries are marked as ambiguous and have the corresponding responses that are incorrect, while the fourth queries are marked as unambiguous and have the corresponding responses that are correct. These queries are disregarded because misclassifications do not impact whether the corresponding responses were correct. For example, responses to the third queries are incorrect regardless of whether they are rewritten, and responses to the fourth queries are correct regardless of whether they are rewritten. In contrast, misclassifications of the first and second queries do impact the accuracy of the corresponding responses. Accordingly, the forecasted error rate is a measure of how frequently the ambiguity classifier model will misclassify queries in a manner that impacts response accuracy.

In various examples, the forecasted error rate of the ambiguity classifier model is used as a factor in selecting the ambiguity classifier model (e.g., from among multiple ambiguity classifiers) for use in the ambiguity-guided query rewrite pipeline. For example, the plurality of ambiguity classifiers are associated with forecasted error rates (e.g., determined in accordance with the above-described techniques) in different query categories. In this example, the query is classified (e.g., using a query categorization model) within a particular query category, and the ambiguity classifier model is selected because the ambiguity classifier model exhibits the lowest error rate (e.g., from among the plurality of query classifiers) when classifying queries in the particular query category. Given this, the ambiguity classifier model is selected to classify the query as ambiguous or unambiguous. If classified as ambiguous, the query rewrite model is leveraged to rewrite the query to resolve ambiguities, and the AI chat agent processes the updated query to generate a response. If classified as unambiguous, the unedited query is processed by the AI chat agent to generate a response.

Thus, in contrast to conventional techniques, the described techniques conditionally rewrite a query if the query is classified as ambiguous by the ambiguity classifier model, but refrain from rewriting the query when the query is classified as unambiguous. By refraining from unnecessarily rewriting unambiguous queries, the described techniques prevent introduction of hallucinations to queries that are already unambiguous, which improves response accuracy. Moreover, the described techniques eliminate the query processing latency and computational resource consumption associated with rewriting the query using the query rewrite model when the query is classified as unambiguous, which improves computational performance of the ambiguous query rewrite system as a whole.

### Term Descriptions

As used herein, the term “query” is a user input to an AI chat agent. The query, for instance, represents natural language commands, requests, and/questions provided in a user interface to an AI chat agent that implements a machine learning model and/or LLM to generate a response to the query.

As used herein, the term “prompt” is a structured input to guide a machine learning model to perform one or more functionalities. A prompt, for instance, is configured based on a query to guide a machine learning model to resolve ambiguities in the query. In various examples, the prompt includes input data for consideration by the machine learning model, the query itself (or portions thereof), and instructions for resolving specific types of ambiguities.

As used herein, the term “ambiguity” refers to an instance in which a meaning, intent, and/or scope of a query (either in part or in whole) is unclear and/or is subject to multiple interpretations. Query ambiguities take a variety of forms, examples of which include but are not limited to, vague context or insufficient information, query terms that have multiple interpretations, unclear or unspecified time frames, use of ambiguous pronouns, and typographical errors.

As used herein, the term “enterprise” refers to an organization or a company associated with enterprise-specific terminology. An example of an enterprise is a software company that makes digital products (e.g., software applications) available for use by users that subscribe to the enterprise's products and services. Here, the enterprise-specific terminology refers to terms that are not necessarily proper English words, but are nonetheless accurately spelled in the context of the enterprise, e.g., digital product names and operation names of operations performable using the digital products.

As used herein, the term “artificial intelligence (AI) chat agent” refers to a software application configured to generate conversational responses to queries submitted by a user using AI. To do so, the AI chat agent leverages machine learning models, LLMs, NLP techniques, and NLU techniques. For instance, the AI chat agent is a software program that is built on an LLM. In various examples, the AI chat agent is an enterprise AI chat agent, meaning that the AI chat agent is deployed in connection with products, software applications, and services of an enterprise. For instance, the AI chat agent is accessible via user interfaces of a digital product (e.g., software application) offered by the enterprise.

As used herein, the term “domain” refers to a specific product, service, entity, field, or category of knowledge. In various examples, a domain is the enterprise in connection with which the AI chat agent is deployed. Additionally or alternatively, domains correspond to digital products offered by the enterprise.

As used herein, the term “query category” refers to a category to which a query pertains. In some examples, different enterprise-specific domains correspond to different query categories. Additionally or alternatively, query categories include general knowledge topics, including but not limited to, clothing, electronics, artificial intelligence, automotive, and the like.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

As used herein, the term “large language model (LLM)” refers to a type of machine learning model that is pre-trained on vast amounts of text data to understand, generate, and analyze human language. Examples of LLMs include, but are not limited to, generative pre-trained transformer (GPT) models, LLAMA models, and bi-directional encoder representations from transformers (BERT) models, and their variants. In various examples, LLMs are fine-tuned on domain-specific (e.g., enterprise-specific) datasets to understand text-strings and contextual information specific to a particular domain and/or enterprise. In at least one example, an LLM is publicly available, meaning that the LLM is accessible by entities (e.g., the enterprise) via APIs.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

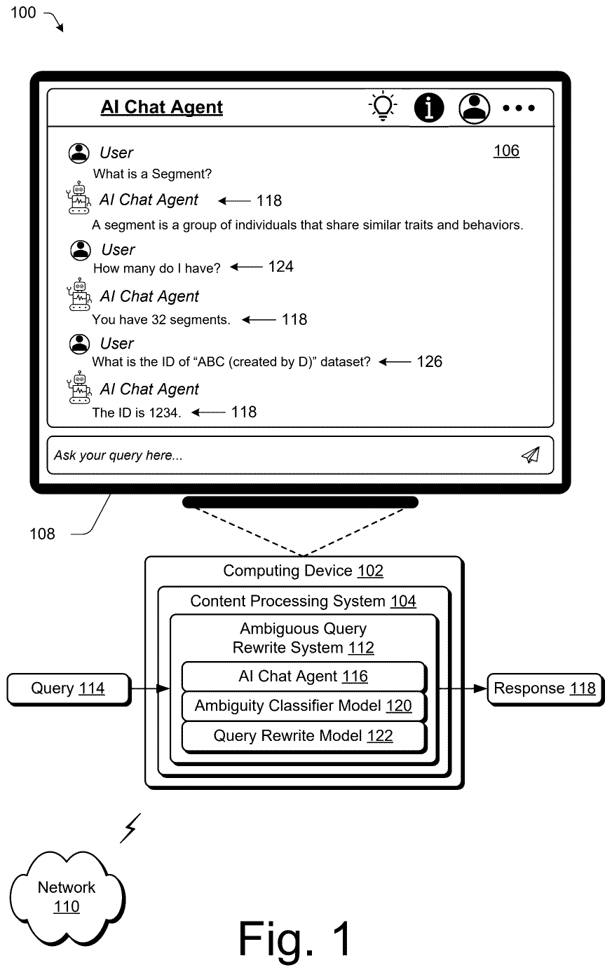

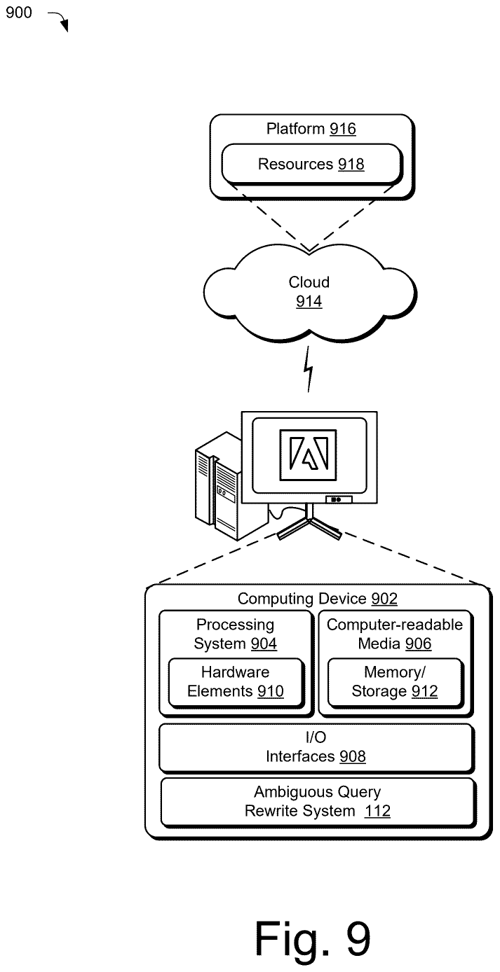

FIG. 1 is an illustration of an environment in an example implementation that is operable to employ techniques described herein for ambiguity-guided query rewrite for an artificial intelligence (AI) chat agent. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as an ambiguous query rewrite system 112. In accordance with the described techniques, the ambiguous query rewrite system 112 is configured to determine whether to rewrite a query 114 posed by a user to an AI chat agent 116. The AI chat agent 116, for instance, is a software program designed to simulate human-like conversations with a user using AI. The query 114 is a user input requesting the AI chat agent 116 to respond to specific commands, requests, and questions within the query 114. In response, the AI chat agent 116 processes the query 114 to generate a response 118, which in various implementations, is a natural language output (e.g., an answer) to the commands, requests, and questions posed by the query 114.

To determine whether to rewrite the query 114, the ambiguous query rewrite system 112 employs an ambiguity classifier model 120, which is a machine learning model configured and/or trained to classify the query 114 as ambiguous or unambiguous. If the ambiguity classifier model 120 classifies the query 114 as ambiguous, the query 114 is provided as input to a query rewrite model 122. Broadly, the query rewrite model 122 is a machine learning model (e.g., a large language model (LLM)) trained, configured, and/or prompted to rewrite the query 114 to resolve query ambiguities. Upon rewriting the query 114, the query rewrite model 122 provides the rewritten query to the AI chat agent 116 for processing. Here, the AI chat agent 116 generates the response 118 to the rewritten query, and the response 118 is output for display in the user interface 106. In contrast, if the ambiguity classifier model 120 classifies the query 114 as unambiguous, the query rewrite model 122 provides the unedited query directly to the AI chat agent 116 for processing, e.g., without first rewriting the query 114 using the query rewrite model 122. Here, the AI chat agent 116 generates the response 118 to the unedited query, and the response 118 is output for display in the user interface 106.

In the illustrated example, for instance, the query 114-“how many do I have?” is classified as an ambiguous query 124 by the ambiguity classifier model 120. Accordingly, the query rewrite model 122 rewrites the ambiguous query 124 to resolve the ambiguities, and the rewritten query is “how many segments do I have?” The AI chat agent 116 processes the rewritten query to generate a response 118—“you have 32 segments.” Furthermore, the query 114—“what is the ID of ‘ABC (created by D)’ dataset?” is classified as an unambiguous query 126 by the ambiguity classifier model 120. Accordingly, the ambiguous query rewrite system 112 provides the unambiguous query 126 directly to the AI chat agent 116 for processing without modifying the unambiguous query 126. In response, the AI chat agent 116 generates a response 118 to the unambiguous query 126 “the ID is 1234.”

Conventional query rewriting techniques for AI chat agents rewrite queries unconditionally. That is, conventional techniques rewrite all queries submitted by a user regardless of whether the queries are ambiguous or not. Rewriting unambiguous queries unnecessarily increases the risk of the query rewrite model 122 introducing hallucinations to the queries, which causes inaccurate responses. This problem is further exacerbated by the notion that the user frequently asks questions that depend on information from these inaccurate responses, which leads to even more inaccurate responses.

In addition to the accuracy-related problems, unconditionally rewriting queries involves unnecessarily processing queries using query rewrite model(s), which increases query processing latency and consumption of computational resources, e.g., processing resources, network resources, and/or memory resources. Indeed, query rewrite models are often implemented using publicly available LLMs, and as such, each instance of a query rewrite instance involves communicating the query over the network 110 to an API endpoint, rewriting the query by the LLM, and receiving a response that includes the rewritten query. This operation is costly in terms of latency, network bandwidth consumption, and processing resource consumption, e.g., to process the query using the LLM.

In contrast to conventional techniques, the described techniques conditionally rewrite a query 114 if the query 114 is classified as ambiguous by the ambiguity classifier model 120, but refrain from rewriting the query 114 when the query is classified as unambiguous. By refraining from unnecessarily rewriting unambiguous queries, the described techniques prevent introduction of hallucinations to queries that are already unambiguous, which improves response accuracy. Moreover, the described techniques eliminate the query processing latency and computational resource consumption associated with rewriting the query 114 using the query rewrite model 122 when the query 114 is classified as unambiguous, which improves computational performance of the ambiguous query rewrite system 112 as a whole.

### Ambiguity-Guided Query Rewrite Features

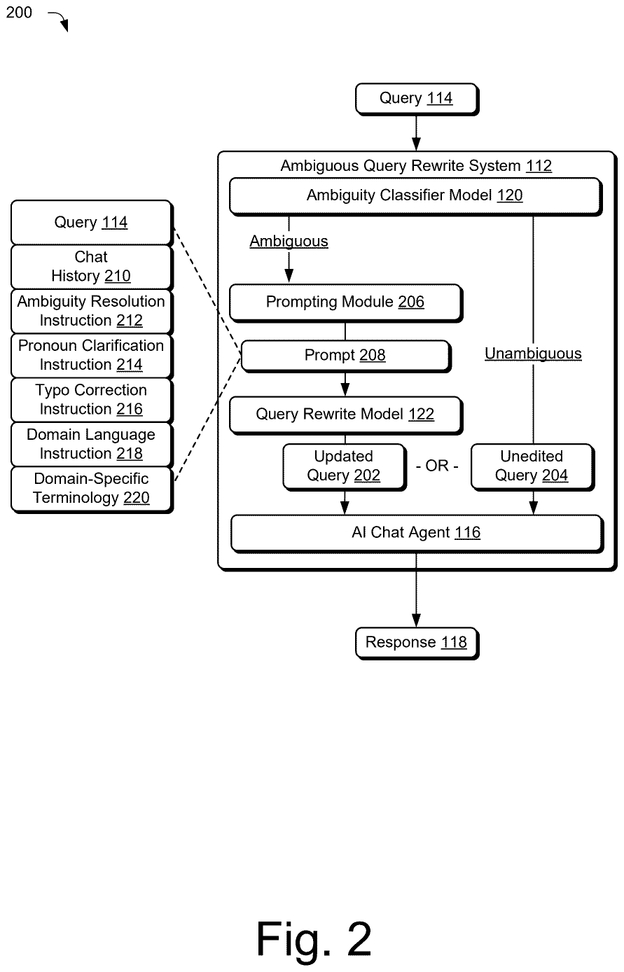

FIG. 2 depicts a system 200 in an example implementation showing operation of an ambiguous query rewrite system to determine whether to rewrite a query based on query ambiguity. As shown, the system 200 includes the AI chat agent 116, the ambiguity classifier model 120, and the query rewrite model 122 of FIG. 1. As previously mentioned, the AI chat agent 116 is a software program designed to simulate human-like conversations with a user using AI. To facilitate this functionality, the AI chat agent 116 leverages machine learning models, large language models (LLMs), natural language understanding (NLU) techniques, and/or natural language processing (NLP) techniques. In various examples, the AI chat agent 116 is an enterprise AI chat agent 116 deployed in connection with products, software applications, and services of an enterprise, e.g., a business or organization. That is, the AI chat agent 116 is designed to generate accurate conversational responses to enterprise-specific commands, requests, questions, and the like. As part of this, an LLM (on which the AI chat agent 116 is built) is fine-tuned to understand enterprise-specific terminology, such as being trained on a refined dataset to understand text-strings and contextual information pertaining to the enterprise.

In one specific example, the enterprise is a software company that offers a variety of software programs (e.g., digital products) for its users, such as web design tools, image editing and graphic design, photo manipulation and vector creation, document management services, mobile app development, print layout and animation software, and so on. In this example, the AI chat agent 116 is deployed in connection with these digital products, thereby enabling users to query the AI chat agent 116 regarding the digital products within user interfaces of the digital products. In this example, the AI chat agent 116 is built on one or more LLMs. Any one or more of a variety of LLMs are capable of implementing the AI chat agent, examples of which include GPT-3, GPT-4, Llama 2, Llama 3 and fine-tuned variants thereof.

These example functionalities of the AI chat agent 116, however, are not to be construed as limiting. Indeed, the AI chat agent 116 is built on smaller enterprise-specific machine learning models in variations. These models are trained from scratch (e.g., starting with randomly initialized parameters) using a refined dataset that includes enterprise-specific terminology. Although depicted and described herein as an enterprise AI chat agent 116, the techniques described are additionally applicable to general-purpose AI chat agents 116.

The ambiguity classifier model 120 is a machine learning model trained to classify a query as ambiguous or unambiguous. In one example, the ambiguity classifier model 120 is trained on a dataset including a plurality of training samples. Each training sample of the dataset includes a training query and a label indicating whether the training query is ambiguous or unambiguous. During training, the ambiguity classifier model 120 receives a training sample, and processes the training query of the training sample to output a determination of whether the training query is ambiguous or unambiguous. Furthermore, a loss is calculated that captures a difference between the model output and the label of the training sample, and parameters (e.g., internal weights) of the ambiguity classifier model 120 are updated to minimize the loss. This process is repeated on a plurality of training samples until the loss converges to a minimum, a threshold number of training samples are processed, or a threshold number of epochs are processed.

In one or more implementations, the ambiguity classifier model 120 is trained from scratch (e.g., starting with randomly initialized parameters) on a dataset including training queries entered via the enterprise AI chat agent 116, e.g., including enterprise-specific terminology. By using a specifically-trained ambiguity classifier model 120 (e.g., as opposed to a pre-trained LLM or a fine-tuned variant thereof), the ambiguity classifier model 120 is significantly smaller (e.g., in terms of memory occupation) than an LLM. This enables the enterprise to store and run the ambiguity classifier on hardware resources (e.g., memory and central processing units (CPUs)) owned and operated by the enterprise. This also eliminates costly (e.g., in terms of latency and financial costs) API calls associated with prompting an LLM to classify a query as ambiguous or unambiguous.

The ambiguity classifier model 120, however, is not limited by the method of training or the model architecture. Rather, the ambiguity classifier model 120 is any machine learning model (e.g., including those trained from scratch, pre-trained LLMs, and fine-tuned LLM variants) trained to classify queries as ambiguous or unambiguous.

As previously mentioned, the query rewrite model 122 is a machine learning model trained, configured, and/or prompted to rewrite the query 114 to resolve query ambiguities. In one or more implementations, the query rewrite model 122 is a publicly available LLM. Any one or more of a variety of publicly available LLMs are usable by the ambiguous query rewrite system, examples of which include a GPT-3.5-Turbo Model, a LLAMA-3-70B Model, and fine-tuned variants thereof. In these implementations, the ambiguous query rewrite system 112 uses the query rewrite model 122 to rewrite and/or update a query by communicating an API call over the network 110 to an API endpoint associated with the LLM. The API call includes a prompt having data and instructions for updating the query to resolve ambiguities, as discussed in more detail below. Once the API call is received by the API endpoint, the LLM (e.g., the query rewrite model 122) rewrites the query to generate an updated query 202 that resolves the ambiguities in accordance with the prompt. Finally, an API response including the updated query 202 is received over the network 110 from the API endpoint.

Although the query rewrite model 122 is described herein as a publicly available LLM, this example is not to be construed as limiting. Rather, the query rewrite model 122 is any machine learning model (e.g., including pre-trained LLMs, fine-tuned variants of publicly available LLMs, and machine learning models trained from scratch) capable of rewriting a query to resolve ambiguities, whether the model is trained and/or prompted to do so.

As shown, the ambiguous query rewrite system 112 receives a query 114 representing commands, questions, and comments for responding to by the AI chat agent 116. In particular, the query 114 is provided as input to the ambiguity classifier model 120, which outputs a determination of whether the query is ambiguous or unambiguous. An ambiguity in the query 114, for instance, represents an instance in which a meaning, intent, and/or scope of the query is unclear and/or subject to multiple interpretations. Query ambiguities thus hinder an ability of the AI chat agent 116 to generate an accurate response to the query 114. Query ambiguities take a variety of forms, examples of which include, but are not limited to, vague context or insufficient information, query terms that have multiple interpretations, unclear or unspecified time frames, use of ambiguous pronouns, and typographical errors.

In response to classifying the query 114 as unambiguous, the ambiguous query rewrite system 112 provides an unedited query 204 to the AI chat agent 116 for processing. Here, the unedited query 204 is the query 114 as entered by the user, without any edits or modifications to the query 114. The AI chat agent 116 is configured to process the unedited query 204 to generate a natural language response 118 to the unedited query 204, which is output for display in the user interface 106.

However, if the ambiguity classifier model 120 classifies the query 114 as ambiguous, the query 114 is provided as input to a prompting module 206. Broadly, the prompting module 206 is representative of functionality for building a prompt 208 that requests the query rewrite model 122 to update the query 114 to resolve query ambiguities. The prompt 208 is a structured input guiding the ambiguous query rewrite system 112 to perform one or more functionalities, namely, to rewrite the query to resolve query ambiguities. In various examples, the prompt 208 includes input data, instructions, and the like. For instance, the prompt 208 includes one or more of the query 114, a chat history 210, an ambiguity resolution instruction 212, a pronoun clarification instruction 214, a typo correction instruction 216, a domain language instruction 218, and domain-specific terminology 220.

Generally, the chat history 210 is representative of one or more previous queries submitted by the user and one or more previous responses generated by the AI chat agent 116. That is, the previous queries were submitted by the user and the previous responses were generated by the AI chat agent 116 and displayed in the user interface 106 prior to the user submitting the query 114. By way of example, the chat history 210 includes up to a predefined number (e.g., five) of the most recently submitted queries by the user, and the corresponding responses to those queries as generated by the AI chat agent 116.

The ambiguity resolution instruction 212 is a text-based input instructing the query rewrite model 122 to rewrite the query 114 to resolve ambiguities based on the chat history 210. Notably, the ambiguity resolution instruction 212 instructs the query rewrite model 122 to resolve ambiguities generally, without specifying particular ambiguities to address.

The pronoun clarification instruction 214 is a text-based input instructing the query rewrite model 122 to rewrite the query 114 to resolve ambiguous pronouns in the query 114. For example, the pronoun clarification instruction 214 instructs the query rewrite model 122 to replace ambiguous pronouns with nouns that the pronouns refer to. The typo correction instruction 216 is a text-based input instructing the query rewrite model 122 to rewrite the query 114 to correct typographical errors in the query 114.

The domain language instruction 218 is a text-based input instructing the query rewrite model 122 to preserve domain-specific terminology within the query 114. By way of example, the query 114 is received in connection with a particular domain. Generally, a domain is a specific product, service, entity, field, or category of knowledge. In one example, a domain is the enterprise in connection with which the AI chat agent 116 is deployed. In this example, the query 114 is received in connection with the enterprise, meaning that the query 114 is submitted by a user via a user interface of a software program made available by the enterprise. The domain language instruction 218 in this example instructs the query rewrite model 122 to preserve any enterprise-specific terms (e.g., without modifying them) in the query 114.

This combination of instructions enables the query rewrite model 122 (e.g., the LLM) to utilize its NLU capabilities to identify and correct ambiguities not addressed by specific prompt instructions, while focusing on correcting specific types of ambiguities that often lead to inaccurate responses by the AI chat agent 116, such as pronoun ambiguities, typographical errors, and modification of domain-specific terms.

In various examples, the prompt 208 additionally includes domain-specific terminology 220, and the domain language instruction 218 instructs the query rewrite model 122 to preserve any terms in the query 114 that are also present in the domain-specific terminology 220. Continuing with the previous example in which the domain is the enterprise, the ambiguous query rewrite system 112 maintains a database of enterprise-specific terms in memory. These terms may not be proper English words, but are nonetheless unambiguous in the context of queries received by the AI chat agent 116 deployed in connection with the enterprise. Examples of the enterprise-specific terms include digital product names and names of operations that are performable via those digital products. In the context of an example enterprise named “Tech Vista,” the enterprise terminology includes “Tech Vista,” “PixelPro” (e.g., a name of a photo editing application made available by PixelPro), and “ColorFusion,” e.g., a name of an operation performable in the photo editing application to automatically adjust color balance in a photo. In this example, the enterprise-specific terms are included in the prompt 208 as part of the domain-specific terminology 220.

Additionally or alternatively, the ambiguous query rewrite system 112 pairs different sets of domain-specific terminology 220 associated with different domains in memory. In this way, when the query 114 is received in connection with a particular domain, the domain-specific terminology 220 associated with the particular domain is retrieved from memory and added to the prompt. Examples of the domains include particular software programs (e.g., digital products) offered by the enterprise. In this example, the ambiguous query rewrite system 112 pairs different digital products with different sets of product-specific terminology. Terminology paired with a digital product include names of operations (e.g., “ColorFusion”) that are performable using the digital product. Thus, when a query 114 is input by a user via a user interface of a particular digital product, the product-specific terminology is retrieved from memory, and added to the prompt 208 as part of the domain-specific terminology 220. In some implementations, general enterprise terminology (e.g., that is applicable to various digital products offered by the enterprise) is automatically included in the prompt 208 as part of the domain-specific terminology 220 (in addition to the product-specific terminology), regardless of the digital product from which the query 114 is received.

As shown, the query rewrite model 122 receives the prompt 208, and generates an updated query 202 by rewriting the query 114 to resolve ambiguities based on the prompt 208. That is, the query rewrite model 122 generates the updated query 202 by analyzing input data (e.g., the query 114, the chat history 210, and/or the domain-specific terminology 220) of the prompt 208 and following the instructions 212, 214, 216, 218 of the prompt 208. Once the updated query 202 is generated, the ambiguous query rewrite system 112 provides the updated query 202 to the AI chat agent 116 for processing. The AI chat agent 116 is configured to process the updated query 202 to generate a natural language response 118 to the updated query 202, which is output for display in the user interface 106.

In one or more implementations, the operation of determining whether the query is ambiguous or unambiguous is performed by running the ambiguity classifier model 120 on proprietary hardware resources (e.g., CPUs) owned and operated by the enterprise, while the operation of rewriting the query is performed by calling, via an API, the query rewrite model 122, as previously mentioned. Furthermore, the ambiguity classifier model 120 is trained from scratch allowing for lightweight implementation of the ambiguity classifier model 120, as previously discussed. Given this, running the ambiguity classifier model 120 is significantly less computationally intensive and significantly faster (e.g., in terms of processing latency) than calling the query rewrite model 122.

By way of example, the ambiguity classifier model 120 is associated with a first computational cost, the query rewrite model 122 is associated with a second computational cost, and the first computational cost is less than the second computational cost by at least a threshold amount, e.g., by a multiplier of five. Here, computational costs refer to the amount of computational resources (e.g., processor resources, memory resources, network resources) consumed while inferencing a machine learning model. In addition, the ambiguity classifier model 120 is associated with a first inferencing latency, the query rewrite model 122 is associated with a second inferencing latency, and the first inferencing latency is less than the second inferencing latency by at least a threshold amount, e.g., by a multiplier of five.

By leveraging models exhibiting these latency and computational resource consumption characteristics, the described techniques ensure reduction of computational resource consumption and inferencing latency over conventional techniques that unconditionally rewrite queries. Indeed, the described techniques avoid unnecessary LLM-based query rewrite operations (and the costly inferencing latency and computational resource consumption associated therewith) by determining whether a query 114 is ambiguous, and refraining from sending the query 114 to the query rewrite model 122 if the query is unambiguous. However, to do so, the described techniques leverage an additional operation (e.g., not performed by conventional unconditional query rewrite systems) of using the ambiguity classifier model 120 to classify a query 114 as ambiguous or unambiguous. Since the inferencing latency and computational resource consumption of the ambiguity classifier model 120 are reduced in comparison to the query rewrite model 122, the ambiguous query rewrite system 112 experiences net reductions in inferencing latency and computational resource consumption despite this additional operation. Since the computational resource consumption of the query rewrite model 122 is passed to the enterprise accessing the LLM in the form of API fees, the reduction in computational resource consumption also saves the enterprise financial costs.

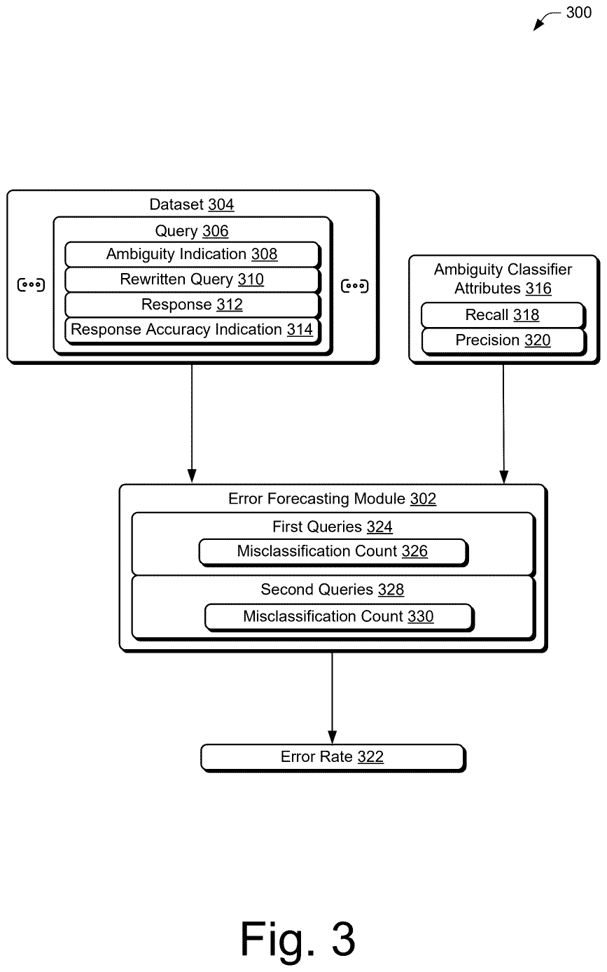

FIG. 3 depicts a system 300 in an example implementation showing operation of an error forecasting module to forecast an error rate at which an ambiguity classifier model misclassifies queries. As shown, the error forecasting module 302 receives a dataset 304, and the dataset 304 includes a plurality of queries 306. In the context of an enterprise AI chat agent 116, for instance, the queries 306 are written by users and submitted to the enterprise AI chat agent 116 for answering. Each of the queries 306 includes an ambiguity indication 308, which for example, is an output by the ambiguity classifier model 120 indicating whether the query is ambiguous or unambiguous. A positive ambiguity indication 308 specifies that the query 306 is ambiguous, while a negative ambiguity indication 308 specifies that the query 306 is unambiguous.

In addition, each query 306 is associated with a rewritten query 310, which is representative of the query 306 as rewritten by the query rewrite model 122 to resolve and/or reduce ambiguities in accordance with the described techniques. Notably, each query 306 of the dataset 304 is associated with a rewritten query 310 regardless of whether the query 306 is ambiguous. In addition, each query 306 is associated with a corresponding response 312, as generated by the AI chat agent 116 by processing the rewritten query 310. That is, the response 312 is generated by processing the rewritten query 310, not the original query 306.

Finally, each query 306 is associated with an response accuracy indication 314, which is an indication of whether the response 312 accurately answers the query 306. A positive response accuracy indication 314 indicates that the response 312 is correct, while a negative response accuracy indication 314 indicates that the response 312 is incorrect. In various examples, the response accuracy indications 314 are generated by human annotators.

In addition, the error forecasting module 302 receives ambiguity classifier attributes 316 describing performance characteristics of the ambiguity classifier model 120 being evaluated. In particular, the ambiguity classifier attributes 316 include recall 318 and precision 320. Generally, recall 318 measures the proportion of ambiguous queries 306 that are correctly classified as ambiguous by the ambiguity classifier model 120. Precision 320, on the other hand, measures the proportion of total queries classified as ambiguous by that are correctly classified. Recall 318 and precision 320 are expressible mathematically by the following equations:

$$Recall = \frac{True Positives}{True Positives + False Negatives}$$

$$Precision = \frac{True Positives}{True Positives + False Negatives}$$

In the equations above, true positives are the queries 306 correctly classified as ambiguous by the ambiguity classifier model 120, false negatives are queries 306 that are classified as unambiguous but are, in fact, ambiguous, and false positives are queries 306 that are classified as ambiguous but are, in fact, unambiguous.

Generally, the error forecasting module 302 is configured to forecast an error rate 322 at which the ambiguity classifier model 120 will classify queries in a manner that impacts response accuracy by the AI chat agent 116. The forecasted error rate 322 is based on the dataset 304, the recall 318, and the precision 320.

More specifically, to forecast the error rate 322, the error forecasting module 302 identifies, from the dataset 304, first queries 324 that are classified as ambiguous (e.g., marked with a positive ambiguity indication 308) and have corresponding responses 312 that are correct, e.g., marked with a positive response accuracy indication 314. Furthermore, the error forecasting module 302 calculates, based on the recall 318, a misclassification count 326 representing a number of the first queries 324 that are predicted to be misclassified by the ambiguity classifier model 120.

In addition, the error forecasting module 302 identifies, from the dataset 304, second queries 328 that are classified as unambiguous (e.g., marked with a negative ambiguity indication 308), and have corresponding responses 312 that are incorrect, e.g., marked with a negative response accuracy indication 314. Furthermore, the error forecasting module 302 calculates, based on the recall 318 and the precision 320, a misclassification count 330 representing a number of the second queries 328 that are predicted to be misclassified by the ambiguity classifier model 120. Finally, the error forecasting module 302 generates, as the error rate, a sum of the misclassification count 326 and the misclassification count 330, divided by the total number of queries 306 in the dataset 304.

More specifically, the error forecasting module 302 computes a total number of ambiguous queries 306 (e.g., marked with positive ambiguity indication 308), and a total number of unambiguous queries 306, e.g., marked with a negative ambiguity indication 308. Further, the error forecasting module 302 computes a number of true positives within the ambiguous queries 306 based on the recall 318 using the following equation:

$$TP\_Ambiguous = R \times AQ$$

In the equations above, TP_Ambiguous is the count of true positives in the ambiguous queries 306 (e.g., ambiguous queries correctly classified as ambiguous), R is the recall 318, and AQ is the total count of ambiguous queries 306 in the dataset 304.

In addition, the error forecasting module 302 calculates the false positives for unambiguous queries 306 using based on the precision using the following equation:

$$FP\_Unambiguous = ( 1 / P - 1 ) \times TP\_Ambiguous$$

In the equations above, FP_Unambiguous is the count of false positives in the unambiguous queries 306 (e.g., unambiguous queries incorrectly classified as ambiguous), P is the precision 320, and TP_Ambiguous is the count of true positives in the ambiguous queries 306.

Furthermore, the error forecasting module 302 proportionally attributes false positives of the unambiguous queries 306 to a subgrouping of the unambiguous queries 306 having corresponding responses 312 that are marked as incorrect, e.g., with a negative response accuracy indication 314. To do so, the error forecasting module 302 leverages the following equation:

$$FP\_Unambiguous \_Incorrect = FP\_Unambiguous \times \frac{UQI}{UQ}$$

In the equation above, FP_Unambiguous_Incorrect is the count of false positives within a subgrouping of the unambiguous queries 306 having corresponding responses 312 that are incorrect. In other words, FP_Unambiguous_Incorrect captures a number of unambiguous queries 306 with corresponding incorrect responses 312 that are incorrectly classified as ambiguous. Further, FP_Unambiguous is the count of false positives in the unambiguous queries, UQI is the count of unambiguous queries 306 having corresponding responses 312 marked as incorrect, and UQ is the count of unambiguous queries 306.

Finally, the error forecasting module 302 computes the misclassification count 326 and the misclassification count 330 using the following equations:

$${MC\_Count}_{-} 1 = ( 1 - R ) \times AQC$$

$${MC\_Count}_{-} 2 = FP\_Unambiguous \_Incorrect$$

In the equations above, MC_Count_1 is the misclassification count 326 of the first queries 324, MC_Count_2 is the misclassification count 330 of the second queries 328, R is the recall 318, and FP_Unambiguous_Incorrect is the count of false positives within a subgrouping of the unambiguous queries 306 having corresponding responses 312 that are incorrect.

Notably, the error forecasting module 302 disregards (e.g., omits from the computation of the error rate 322) third queries 306 and fourth queries 306 in the dataset 304. The third queries 306 are classified as ambiguous (e.g., marked with a positive ambiguity indication 308) and have corresponding responses 312 that are incorrect, e.g., marked with a negative response accuracy indication 314. The fourth queries 306 are classified as unambiguous (e.g., marked with a negative ambiguity indication 308) and have corresponding responses 312 that are correct, e.g., marked with a positive ambiguity indication 308.

The purpose for disregarding the third queries 306 and the fourth queries 306 is because rewriting these queries 306 does not impact whether the corresponding responses 312 were correct. This conclusion is based on the following assumptions: (1) if the ambiguity classifier model 120 has 100% recall, it will not miss misclassify any query that is, in fact, ambiguous (e.g., is to be rewritten), and (2) if a query is unambiguous, the AI chat agent 116 will generate a correct response without being rewritten. The third queries 306 are classified as ambiguous, and the responses 312 to the rewritten versions of the third queries (e.g., the rewritten queries 310) are incorrect (e.g., marked with a negative response accuracy indication 314). As such, whether the query 306 is rewritten or not, the AI chat agent 116 produces an incorrect response. The fourth queries 306 are classified as unambiguous, and the responses 312 to the rewritten versions of the fourth queries 306 (e.g., the rewritten queries 310) are correct, e.g., marked with a positive response accuracy indication 314. As such, whether the query 306 is rewritten or not, the AI chat agent 116 produces correct response.

In contrast, the first queries 324 are classified as ambiguous, and the rewritten versions of the first queries 324 (e.g., the rewritten queries 310) are correct. Given this, a first query 324 will cause an incorrect response if not rewritten, but will cause a correct response when rewritten. Furthermore, the second queries 328 are classified as unambiguous, and the rewritten versions of the second queries 328 (e.g., the rewritten queries 310) are incorrect. Given this, a second query 328 will cause a correct response if not rewritten, but will cause an incorrect response when rewritten, e.g., via the query rewrite model 122 introducing errors. Thus, by considering the misclassification counts 326, 330 of the first queries 324 and the second queries 328 while disregarding the third queries and the fourth queries, the error rate 322 represents a predicted rate at which the ambiguity classifier model 120 will misclassify queries in a manner that impacts response accuracy.

Given a dataset 304 and known recall 318 and precision 320 values for an ambiguity classifier model 120, the error forecasting module 302 is able to generate the error rate 322 before the ambiguity classifier model 120 is deployed in the ambiguous query rewrite system 112. In some examples, the error forecasting module 302 generates an error rate 322 for the ambiguity classifier model 120, and the ambiguous query rewrite system 112 is only used (e.g., to classify queries as ambiguous or unambiguous for determining whether to bypass the query rewrite model 122 when responding to the queries using the AI chat agent 116) if the error rate 322 is below a threshold. Otherwise, a different query rewrite system is used, e.g., an unconditional query rewrite system. Additionally or alternatively, the error forecasting module 302 is leveraged to test different values of the recall 318 and precision 320 to get a minimum recall value and a minimum precision value that produces a desired error rate by the error forecasting module 302. Furthermore, ambiguity classifiers that meet the minimum recall value and the minimum precision value are integrated in the ambiguous query rewrite system 112.

The error forecasting module 302 enables developers to determine how the ambiguous query rewrite system 112 will perform before deployment. Running the error forecasting module 302 to determine the error rate 322 consumes significantly less computational resources (e.g., processing resources and network bandwidth resources) than running the ambiguous query rewrite system 112 during deployment to obtain sufficient data for determining an accurate error rate. Thus, by forecasting the error rate 322 for the ambiguity classifier model 120 before deploying the ambiguous query rewrite system 112, the described techniques conserve computational resources, and improve computer performance.

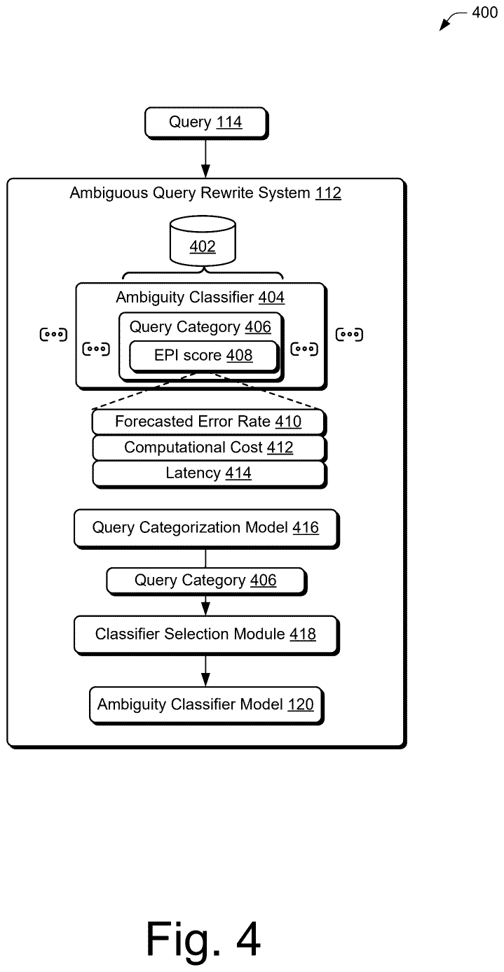

FIG. 4 depicts a system 400 in an example implementation showing operation of an ambiguous query rewrite system 112 to select an ambiguity classifier. Here, the ambiguous query rewrite system 112 is illustrated as including a database 402, and the database includes indications of different ambiguity classifiers 404, one example of which is the ambiguity classifier model 120. Generally, the different ambiguity classifiers 404 are trained differently (e.g., on different training data) and/or have different model architectures. Examples of the the ambiguity classifiers 404 include, but are not limited to, machine learning models trained from scratch on domain-specific datasets (e.g., ran and stored on proprietary computer hardware of the enterprise) and general-purpose or fine-tuned variants of publicly available LLMs, e.g., ran and stored by external entities and accessible by the enterprise via APIs.

As shown, each of the ambiguity classifiers is associated with a plurality of query categories 406, and each query category 406 is associated with an efficiency-performance index (EPI) score 408. Generally, the query categories 406 are different categories of queries, such as general queries (e.g., pertaining to subjects that are not specific to the enterprise), and enterprise-specific (or domain-specific) queries, e.g., pertaining to subjects that are relevant to the enterprise. Additionally or alternatively, the query categories include general knowledge topics (e.g., clothing, electronics, artificial intelligence, automotive, and the like), as well as particular domains within the enterprise, e.g., particular digital products that the enterprise offers. As shown, the EPI score 408 is computed on the basis of a forecasted error rate 410 of the ambiguity classifier 404 with respect to the query category 406, as well as a computational cost 412 (e.g., amount of compute, memory, and/or network bandwidth consumed) and latency 414 (e.g., average time between inputting a query and receiving an ambiguity indication for the query) associated with inferencing the ambiguity classifier 404.

To determine the forecasted error rate 410 of an ambiguity classifier 404 within a particular query category 406, the error forecasting module 302 receives a dataset 304 including a plurality of queries 306 within the particular query category 406. In addition, the error forecasting module 302 receives the recall 318 and precision 320 of the ambiguity classifier 404. In some examples, the ambiguity classifier 404 is associated with different recall 318 and precision 320 values for different query categories 406. Further, the error forecasting module 302 generates the forecasted error rate 410 based on the dataset 304, the recall 318, and the precision 320 in accordance with the techniques discussed above with reference to FIG. 3. The EPI score 408 is then computed by generating a weighted sum of the forecasted error rate 410, the computational cost 412, and the latency 414, with different factors being weighted differently. This process is repeated for each query category 406 and each ambiguity classifier 404, such that each unique ambiguity classifier 404 and query category 406 pair is associated with an EPI score 408.

As shown, the ambiguous query rewrite system 112 receives a query 114, which is provided as input to a query categorization model 416. Broadly, the query categorization model 416 is a machine learning model that is trained and/or prompted to categorize the query 114 into one of the plurality of query categories 406. In one example, the query categorization model 416 is trained on a dataset including a plurality of training samples. Each training sample of the dataset includes a training query and a label indicating a ground truth query category. During training, the ambiguity classifier model 120 receives a training sample, and processes the training query of the training sample to output a predicted query category. Furthermore, a loss is calculated that captures a difference between the model output and the label of the training sample, and parameters (e.g., internal weights) of the query categorization model 416 are updated to minimize the loss. This process is repeated on a plurality of training samples until the loss converges to a minimum, a threshold number of training samples are processed, or a threshold number of epochs are processed.

The query categorization model 416 receives the query 114, and outputs a particular query category 406, as shown. A classifier selection module 418 is then employed to select from the plurality of ambiguity classifiers 404, a particular ambiguity classifier 404 having a highest EPI score 408 within the particular query category 406. In the illustrated example, for instance, the classifier selection module 418 selects the ambiguity classifier model 120. Given this, the ambiguous query rewrite system 112 uses the selected ambiguity classifier model 120 to classify the query 114 as ambiguous or unambiguous for determining whether to bypass the query rewrite model 122 when responding to the query using the AI chat agent 116. Accordingly, the ambiguous query rewrite system 112 uses the ambiguity classifier 404 that exhibits an optimal balance of response accuracy, latency, and computational resource consumption. Although the ambiguity classifier 404 is selected on the basis of the EPI score 408 that combines the forecasted error rate 410, the computational cost 412, and the latency 414, the classifier selection module 418 is programmed to select the ambiguity classifier 404 on the basis of any one or any combination of these metrics in variations.

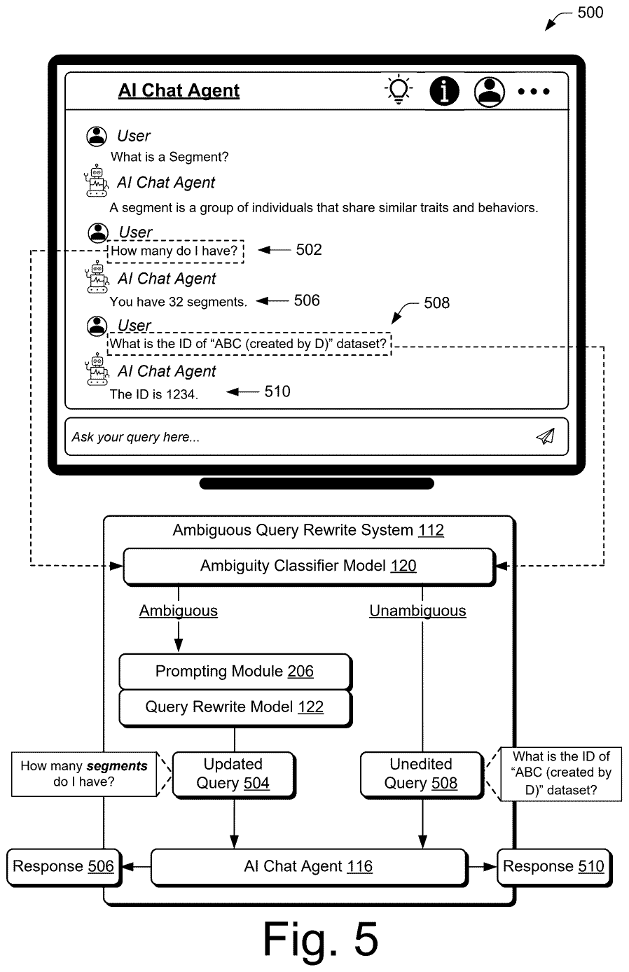

FIG. 5 depicts an example 500 of a user interface displayed in accordance with the described techniques. In the example 500, a user submits a query 502 “how many do I have?” for processing by the AI chat agent 116, and the query 502 is classified as ambiguous by the ambiguity classifier model 120. Accordingly, the prompting module 206 builds the prompt 208 for submission to the query rewrite model 122, which generates an updated query 504 that resolves the ambiguities. Here, the updated query 504 adds the term “segments” such that the updated query 504 recites “how many segments do I have?” The updated query 504 is passed to the AI chat agent 116 for processing. As shown, the AI chat agent 116 generates a response 506 to the updated query 504, and the response is output for display in the user interface.

A subsequent query 508 is submitted by the user for processing by the AI chat agent 116. Here, the query 508 is classified as unambiguous, and as such, the unedited query 508 is passed to the AI chat agent 116 for processing. The AI chat agent 116 generates a response 510 to the unedited query 508, which is output for display in the user interface.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

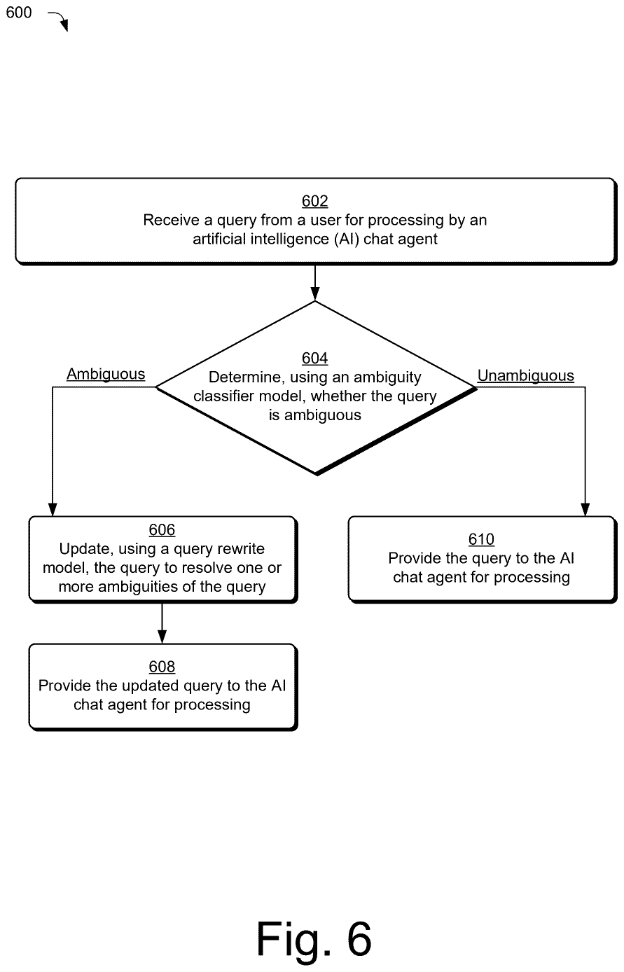

FIG. 6 is a flow diagram depicting an algorithm as a procedure 600 in an example implementation that is performable by a processing device to determine whether to bypass a query rewrite for an AI chat agent. In the procedure 600, a query is received from a user for processing by an AI chat agent (block 602). For example, the user inputs a query 114 including requests, commands, and/or questions for processing by the AI chat agent 116, and the query 114 is received by the ambiguous query rewrite system 112.

An ambiguity classifier model is leveraged to determine whether the query is ambiguous (block 604). For instance, the ambiguity classifier model 120 receives the query 114 as input, and outputs a determination of whether the query is ambiguous or unambiguous.

In response to determining that the query is ambiguous (e.g., “ambiguous” at block 604), the query is updated using a query rewrite model to resolve one or more ambiguities of the query (block 606). By way of example, the prompting module 206 receives the query 114 and builds the prompt 208 based on the query 114. The prompt 208 includes one or more of the query 114, the chat history 210, the ambiguity resolution instruction 212, the pronoun clarification instruction 214, the typo correction instruction 216, the domain language instruction 218, and the domain-specific terminology 220. The prompt 208 is received by the query rewrite model 122, which generates the updated query 202 by rewriting the query 114 to resolve ambiguities based on the input data and instructions of the prompt 208.

The updated query is provided to the AI chat agent for processing (block 608). For example, the updated query 202 is provided to the AI chat agent 116 for processing, and the AI chat agent 116 generates a response 118 by processing the updated query 202.

In response to determining that the query is unambiguous (e.g., “unambiguous” at block 604), however, the query is provided to the AI chat agent for processing (block 610). By way of example, the unedited query 204 is provided to the AI chat agent 116 for processing, and the AI chat agent 116 generates a response 118 by processing the unedited query 204.

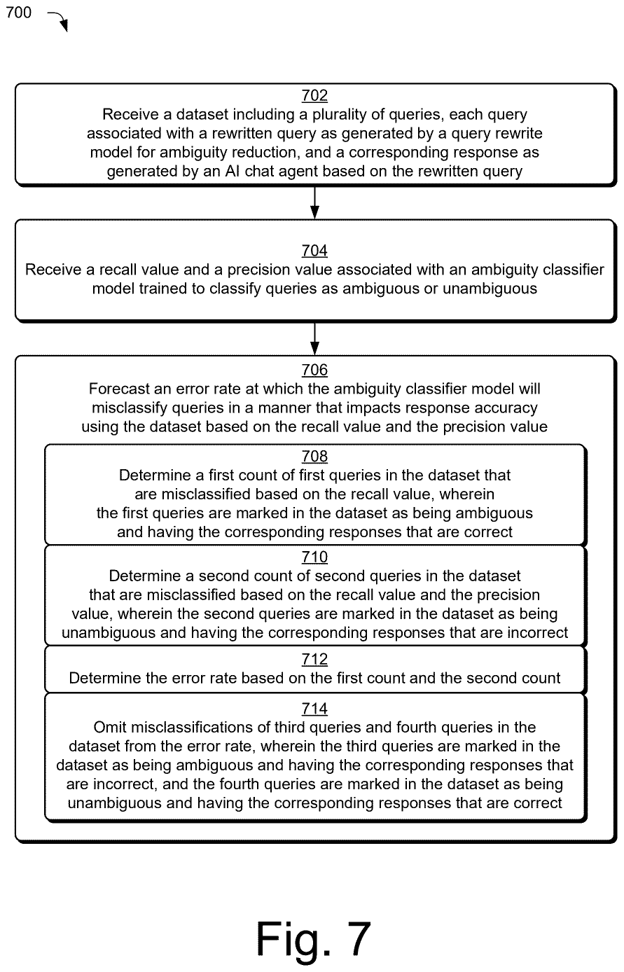

FIG. 7 is a flow diagram depicting an algorithm as a procedure 700 in an example implementation that is performable by a processing device to forecast an error rate for an ambiguity classifier model. In the procedure 700, a dataset including a plurality of queries is received, and each query is associated with a rewritten query as generated by a query rewrite model for ambiguity reduction, and a corresponding response as generated by an AI chat agent based on the rewritten query (block 702). By way of example, the error forecasting module 302 receives a dataset 304 including a plurality of queries 306. Each query 306 is associated with an ambiguity indication 308 (e.g., specifying whether the query 306 is ambiguous), a rewritten query 310 (e.g., the query 306 as rewritten by the query rewrite model 122 to resolve ambiguities), a response 312 (e.g., as generated by the AI chat agent 116 by processing the rewritten query 310), and a response accuracy indication 314, e.g., specifying whether the response 312 is correct.

A recall value and a precision value associated with an ambiguity classifier model are received, and the ambiguity classifier model is trained to classify queries as ambiguous or unambiguous (block 704). For example, the error forecasting module 302 receives the ambiguity classifier attributes 316 of the ambiguity classifier model 120, including recall 318 and precision 320.

An error rate is forecasted at which the ambiguity classifier model will misclassify queries in a manner that impacts response accuracy using the dataset based on the recall value and the precision value (block 706). By way of example, the error forecasting module 302 determines the error rate 322 for the ambiguity classifier model 120 based on the recall 318, the precision 320, and the dataset 304. The error rate 322 captures a rate at which the ambiguity classifier model 120 misclassifies queries in a manner that impacts response accuracy.

As part of this, a first count of first queries in the dataset that are misclassified is determined based on the recall value, and the first queries are marked in the dataset as being ambiguous and having corresponding responses that are correct (block 708). For instance, the error forecasting module 302 identifies, from the dataset 304, first queries 324 that are ambiguous (e.g., marked with a positive ambiguity indication 308), and have the corresponding responses 312 that are correct, e.g., marked with a positive response accuracy indication 314. Furthermore, the error forecasting module 302 computes a misclassification count 326 representing a number of the first queries 324 that are misclassified based on the recall 318.

Further, a second count of second queries in the dataset that are misclassified is determined based on the recall value and the precision value, and the second queries are marked in the dataset as being unambiguous and having the corresponding responses that are incorrect (block 710). For example, the error forecasting module 302 identifies, from the dataset 304, second queries 328 that are unambiguous (e.g., marked with a negative ambiguity indication 308), and have the corresponding responses 312 that are incorrect, e.g., marked with a negative response accuracy indication 314. Furthermore, the error forecasting module 302 computes a misclassification count 330 representing a number of the second queries 328 that are misclassified based on the recall 318 and the precision 320.

The error rate is determined based on the first count and the second count (block 712). By way of example, the error forecasting module 302 determines, as the error rate 322, a sum of the misclassification counts 326, 330 divided by the total queries 306 in the dataset 304.

Misclassifications of third and fourth queries in the dataset are omitted from the error rate, such that the third queries are marked in the dataset as ambiguous and having the corresponding responses that are incorrect, and the fourth queries are marked in the dataset as unambiguous and having the corresponding responses that are correct (block 714). For example, third queries 306 and fourth queries 306 are omitted from the computation of the error rate. The third queries 306 are classified as ambiguous (e.g., marked with a positive ambiguity indication 308) and have corresponding responses 312 that are incorrect, e.g., marked with a negative response accuracy indication. The fourth queries 306 are classified as unambiguous (e.g., marked with a negative ambiguity indication 308) and have corresponding responses 312 that are correct, e.g., marked with a positive ambiguity indication 308. This is because rewriting these queries does not impact the response accuracy.

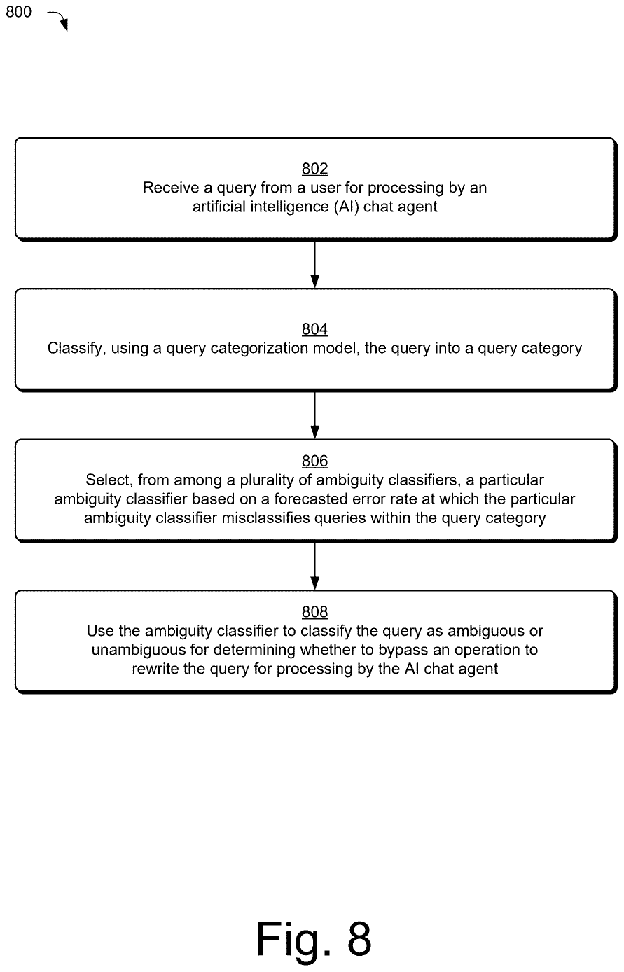

FIG. 8 is a flow diagram depicting an algorithm as a procedure 800 in an example implementation that is performable by a processing device to select an ambiguity classifier model for ambiguity-guided query rewrite for an AI chat agent. In the procedure 800, a query is received from a user for processing by an AI chat agent (block 802). For example, the user inputs a query 114 including requests, commands, and/or questions for processing by the AI chat agent 116, and the query 114 is received by the ambiguous query rewrite system 112.

The query is classified into a query category using a query categorization model (block 804). By way of example, the query categorization model 416 processes the query 114, and outputs a particular query category 406 of the query 114.

A particular ambiguity classifier is selected from among a plurality of ambiguity classifiers based on a forecasted error rate associated with the particular ambiguity classifier (block 806). By way of example, the ambiguous query rewrite system 112 maintains indications of a plurality of ambiguity classifiers 404, and each ambiguity classifier is associated with a plurality of query categories 406. Each ambiguity classifier 404 and query category 406 pairing is associated with an EPI score 408 that is a function of a forecasted error rate 410 of the ambiguity classifier 404 with respect to classifying queries within the query category 406 (as ambiguous or unambiguous), as well as a computational cost 412 and latency 414 associated with inferencing the ambiguity classifier 404. The forecasted error rate 410 for an ambiguity classifier 404 and query category 406 pairing is determined by the error forecasting module 302 based on a dataset 304 of queries 306 within the query category 406, and recall 318 and precision 320 values of the ambiguity classifier, e.g., in accordance with procedure 700. Here, a classifier selection module 418 selects a particular ambiguity classifier 404 exhibiting a highest EPI score 408 within the particular query category 406.

The ambiguity classifier is used to classify the query as ambiguous or unambiguous for determining whether to bypass an operation to rewrite the query for processing by the AI chat agent (block 808). For example, the query rewrite system 112 leverages the selected ambiguity classifier 404 to classify the query 114 as ambiguous or unambiguous. If classified as ambiguous, the query rewrite model 122 is leveraged to generate the updated query 202 by rewriting the query 114 to resolve ambiguities, and the AI chat agent 116 processes the updated query 202 to generate a response 118. If classified as unambiguous, the unedited query 204 is processed by the AI chat agent 116 to generate a response 118.

### Example System and Device

FIG. 9 illustrates an example system generally at 900 that includes an example computing device 902 that is representative of one or more computing systems and/or devices that implement the various techniques described herein. This is illustrated through inclusion of the ambiguous query rewrite system 112. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is s including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” and “system” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a query from a user for processing by an artificial intelligence (AI) chat agent;
determining, using an ambiguity classifier model, whether the query is ambiguous by running the ambiguity classifier model on the processing device;
responsive to determining that the query is ambiguous:
calling an application programming interface (API) endpoint requesting a query rewrite model to update the query to resolve one or more ambiguities of the query, wherein the query rewrite model and the ambiguity classifier model are different machine learning models; and
providing, by the processing device, the updated query to the AI chat agent for processing; and
responsive to determining that the query is unambiguous:
bypassing the query rewrite model; and
providing, by the processing device, an unedited version of the query to the AI chat agent for processing.

2. The method of claim 1, wherein updating the query further includes providing a prompt to the query rewrite model, the prompt including a chat history between the user and the AI chat agent, and an instruction to resolve the one or more ambiguities based on the chat history.

3. The method of claim 2, wherein the prompt provided to the query rewrite model further includes one or more instructions to clarify ambiguous pronouns and correct typographical errors in the query.

4. The method of claim 2, wherein the query is received in connection with a particular domain associated with domain-specific terminology, and the prompt provided to the query rewrite model includes one or more instructions to preserve the domain-specific terminology within the query.

5. The method of claim 4, wherein updating the query further includes:
pairing different sets of domain-specific terminology associated with different domains in memory; and
retrieving the domain-specific terminology associated with the particular domain from the memory, the prompt including the domain-specific terminology.

6. The method of claim 1, wherein a first computational cost is associated with determining whether the query is ambiguous using the ambiguity classifier model, a second computational cost is associated with updating the query using the query rewrite model, and the first computational cost is less than the second computational cost by at least a threshold amount.

7. (canceled)

8. The method of claim 1, further comprising:
receiving a dataset including a plurality of queries, each query associated with a rewritten query as generated by the query rewrite model for ambiguity reduction, and a corresponding response as generated by the AI chat agent based on the rewritten query;
forecasting, by the processing device, an error rate at which the ambiguity classifier model will misclassify queries in a manner that impacts response accuracy using the dataset based on a precision value and a recall value associated with the ambiguity classifier model; and
using, by the processing device and based on the error rate, the ambiguity classifier model to classify queries as ambiguous or unambiguous for determining whether to bypass the query rewrite model when responding to the queries using the AI chat agent.

9. The method of claim 8, wherein the plurality of queries are within a query category, and using the ambiguity classifier model to classify the queries includes:
classifying, using a query categorization model, the query into the query category; and
selecting, from a plurality of ambiguity classifiers, the ambiguity classifier model based on the error rate at which the ambiguity classifier model misclassifies the queries in the query category.

10. The method of claim 8, wherein forecasting the error rate includes:
determining a first count of first queries in the dataset that are misclassified based on the recall value, wherein the first queries are marked in the dataset as being ambiguous and having the corresponding responses that are correct;
determining a second count of second queries in the dataset that are misclassified based on the recall value and the precision value, wherein the second queries are marked in the dataset as being unambiguous and having the corresponding responses that are incorrect; and
determining the error rate based on the first count and the second count.

11. The method of claim 10, wherein forecasting the error rate further includes omitting, from the error rate, misclassifications of third queries and fourth queries in the dataset, wherein the third queries are marked in the dataset as being ambiguous and having the corresponding responses that are incorrect and the fourth queries are marked in the dataset as being unambiguous and having the corresponding responses that are correct.

12. A system comprising:
a memory; and
a processing device coupled to the memory, the processing device to perform operations comprising:
receiving a query from a user for processing by an artificial intelligence (AI) chat agent;
determining, using an ambiguity classifier model, whether the query is ambiguous by running the ambiguity classifier model on the processing device;
responsive to determining that the query is ambiguous:
calling an application programming interface (API) endpoint requesting a query rewrite model to update the query to resolve one or more ambiguities of the query, wherein the query rewrite model and the ambiguity classifier model are different machine learning models; and
providing, by the processing device, the updated query to the AI chat agent for processing; and
responsive to determining that the query is unambiguous:
bypassing the query rewrite model; and
providing an unedited version of the query to the AI chat agent for processing.

13. (canceled)

14. A non-transitory computer-readable medium storing executable instructions, which when executed by a processing device, cause the processing device to perform operations comprising:
receiving a query from a user for processing by an artificial intelligence (AI) chat agent;
determining, using an ambiguity classifier model, whether the query is ambiguous by running the ambiguity classifier model on the processing device;
responsive to determining that the query is ambiguous:
calling an application programming interface (API) endpoint requesting a query rewrite model to update the query to resolve one or more ambiguities of the query, wherein the query rewrite model and the ambiguity classifier model are different machine learning models; and
providing the updated query to the AI chat agent for processing; and
responsive to determining that the query unambiguous:
bypassing the query rewrite model; and
providing, by the processing device, an unedited version of the query to the AI chat agent for processing.

15. (canceled)

16. The non-transitory computer-readable medium of claim 14, wherein updating the query further includes providing a prompt to the query rewrite model, the prompt including a chat history between the user and the AI chat agent, and one or more instructions to resolve the one or more ambiguities based on the chat history by clarifying ambiguous pronouns and correcting typographical errors in the query.

17. The non-transitory computer-readable medium of claim 16, wherein the query is received in connection with a domain associated with domain-specific terminology, and the prompt includes one or more instructions to preserve the domain-specific terminology within the query.

18. The non-transitory computer-readable medium of claim 14, the operations further comprising:
forecasting an error rate at which the ambiguity classifier model will produce misclassifications to queries that have an impact on corresponding responses to the queries based, in part, on a precision value and a recall value associated with the ambiguity classifier model; and
using, based on the error rate, the ambiguity classifier model to classify queries as ambiguous or unambiguous for determining whether to bypass the query rewrite model when responding to the queries using the AI chat agent.

19. The non-transitory computer-readable medium of claim 18, wherein forecasting the error rate includes:
receiving a dataset including a plurality of queries, each query associated with a rewritten query as generated by the query rewrite model for ambiguity reduction, and a corresponding response as generated by the AI chat agent based on the rewritten query; and
forecasting the error rate using the dataset based on the precision value and the recall value.

20. The non-transitory computer-readable medium of claim 19, wherein forecasting the error rate includes:
determining a first count of first queries in the dataset that are misclassified based on the recall value, wherein the first queries are marked in the dataset as being ambiguous and having the corresponding responses that are correct;
determining a second count of second queries in the dataset that are misclassified based on the precision value, wherein the second queries are marked in the dataset as being unambiguous and having the corresponding responses that are incorrect; and
determining the error rate based on the first count and the second count.

21. The method of claim 1, wherein the ambiguity classifier model is stored in memory of the processing device and executed locally on the processing device.

22. The system of claim 12, wherein updating the query further includes providing a prompt to the query rewrite model, the prompt including a chat history between the user and the AI chat agent, and an instruction to resolve the one or more ambiguities based on the chat history.

23. The system of claim 22, wherein the prompt provided to the query rewrite model further includes one or more instructions to clarify ambiguous pronouns and correct typographical errors in the query.
